(19) United States
(12) Patent Application Publication
(10) Pub. No.: US 2009/0234934 A1
(43) Pub. Date: Sep. 17, 2009

(54) MANAGING MULTIPLE NETWORK INTERFACES BY ASSIGNING THEM TO INDIVIDUAL APPLICATIONS

(75) Inventor: Thanh Khai Ong, San Diego, CA (US)

Correspondence Address: FOLEY & LARDNER LLP, P.O. BOX 80278, SAN DIEGO, CA, 92138-0278, US

(73) Assignee: Novatel Wireless, Inc.

(21) Appl. No.: 12/049,200

(22) Filed: Mar. 14, 2008

(51) Int. Cl. G06F 15/16

(52) U.S. Cl. 709/217

(57) ABSTRACT

A multiple network interface system that efficiently utilizes the different interfaces by binding specific applications to them. The system is able to direct selected applications to specified interfaces through a resource management module, which can dynamically or manually bind the application. The resource management module acts as a router within the system, encompassing all the interface connections.

### BACKGROUND OF THE INVENTION

The present invention relates generally to the field of communication devices and more particularly to the management of multiple network interfaces for such communication devices.

Multiple network interfaces are becoming more common with communication devices as there are many different networks from which a user can chose. Often communication devices, such as laptops, are capable of connecting to interfaces such as dial up, Ethernet, Bluetooth, WLAN (802.11 and 3G). Each of these interfaces relies on different protocols in order to communicate with a network. A communication device may connect to a network through one of these interfaces and, then, can have access to multiple services through the network, such as electronic mail (e-mail) and internet access.

Current systems are able to recognize the connection, and the availability of the connection type is visibly apparent. When two or more connection types are available, the system prioritizes the interface type to be used. Once the system has prioritized a specified connection type over another, the selected connection type is used for all communication purposes. For instance on a laptop computer, a user can open a connection with a wireless connection or a hard-wired connection to a network. However, once the computer recognizes the hard-wired connection, it overrides the connection to the wireless network due to connection type, and all communication is conducted via the hard-wired connection.

### SUMMARY OF THE INVENTION

One aspect of the present invention provides a communication method that may interface a communication device with one or more networks through two or more network interfaces while also accessing two or more network services, each network service being accessed through a different one of the two or more network interfaces.

In one embodiment, a resource management module of the communication device may select one or more network interfaces to access network resources corresponding to applications being run on the communication device.

In another embodiment of the present invention, a resource management module may dynamically select a network interface to access network resources based on one or more communication parameters.

In yet another aspect of the present invention, the resource management module may selects a network interface to access network resources for application on a communication device based on predetermined network criteria. In one embodiment, the selection of the network interface may be based on bandwidth. In another embodiment, the selection of a network interface may be based on network signal strength. In yet another embodiment, the selection of a network interface may be based on network security. In another embodiment, the selection of a network interface is based on network signal consistency (type).

Another aspect of the present invention provides that the user of the communication device may select a network interface for each of one or more applications. The selection of the interface may be made manually. In one embodiment, the user programs the resource management module of the communication device to select network interfaces to access network resources corresponding to applications being run on the communication device.

In another embodiment, the user enters predetermined criteria such as bandwidth, network security, network signal strength, or a similar type of criteria, into the resource management module application of the communication device, which may then select network interfaces to access network resources corresponding to applications being run on the communication device.

Another aspect of the present invention provides a communication device, comprising two or more network interfaces adapted to allow access to two or more network services with each network service being accessed through a different one of the two or more network interfaces. Another aspect provides that a resource management module may additionally be incorporated into the communication device and adapted to select network interfaces to access network resources corresponding to applications being run on the communication device. One embodiment provides that the communication device may be a portable computing device.

In one embodiment the network interface type may be 3G DO, IEEE 802.11, Ethernet, dial-up, Bluetooth, or of a similar interface type.

Another embodiment of the present invention provides that a resource management module is adapted to dynamically select a network interface. A further embodiment provides that a resource management module is adapted to select a network interface based on user input.

Yet another aspect of the present invention provides a computer program product for executing a method comprising a program encoded on a computer-readable medium that interfaces a communication device with one or more networks through two or more network interfaces and accesses two or more network services, each network service being accessed through a different one of the two or more network interfaces, when the program is run on a communication device. In one embodiment the computer program product is stored on the communication device.

### BRIEF DESCRIPTION OF THE DRAWINGS

FIG. 1 is an overview diagram of an exemplary embodiment of a system in accordance with the present invention.

FIG. 2 is an block representation of the networks and interfaces and their connection to the communication device according to an embodiment of the present invention.

FIG. 3 is a flow diagram illustrating communication according to an embodiment of the present invention.

FIG. 4 provides a flow diagram of the operation of a resource management module according to an embodiment of the present invention.

FIG. 5 provides a flow diagram of the operation of the resource management module according to another embodiment of the present invention.

FIG. 6 is a schematic representation of the process of the resource management application according to an embodiment of the present invention.

FIG. 7 is an exemplary illustration of the network interface delegation windows on a computer in accordance with an embodiment of the present invention.

### DETAILED DESCRIPTION OF THE PREFERRED EMBODIMENTS

Embodiments of the present invention take advantage of a communication device being provided with multiple network interfaces by allowing the communication device to use two or more interfaces at one time. Such a connection can allow for the selection of an appropriate communication interface, resulting in increased application processing speeds, for example.

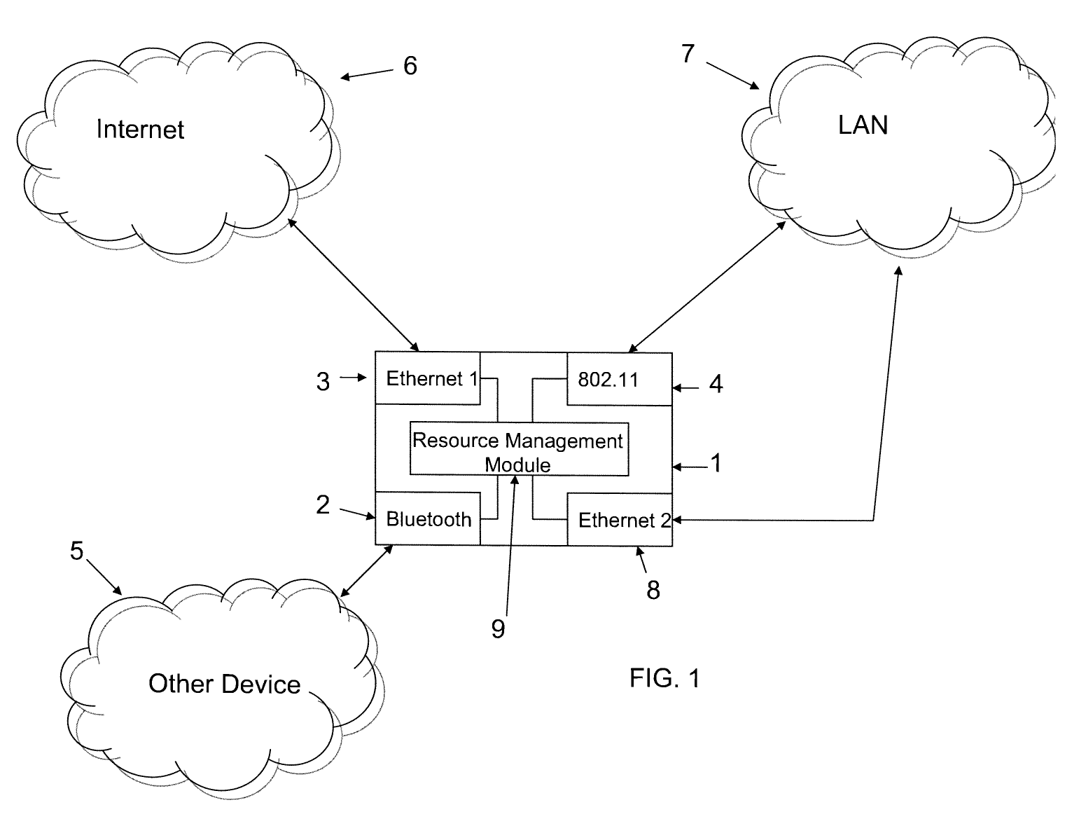

Referring to FIG. 1, a communication device 1 in accordance with an embodiment of the present invention is illustrated. The communication device 1, may be one of any number of types of communication devices, such as a desktop computer, a laptop computer, a personal digital assistant (PDA) or any other such communication device.

The communication device 1 is provided with numerous interfaces to allow different types of connections, such as Bluetooth 2 Ethernet 3 and/or IEEE 802.11 4, to the same or different networks. Each network interface is adapted to allow the communication device 1 to communicate with a network or another communication device. In this regard, the communication device 1 can access network services, such as an email server, the world wide web or other such services, through communication with a network or another device through the network interfaces 2-4.

In accordance with embodiments of the present invention, the network interfaces 2-4 allow the communication device to access two or more network services, each network service being accessed through a different one of the network interfaces. In this regard, network services may include, without limitation, an email server, another communication device, the Internet, a voice-over-IP (VOIP) server and other such services. For example, the communication device 1 can be running an application downloading data through a connection using the Bluetooth interface 2 and may also be instant messaging or e-mailing via a broadband connection, such as through a 802.11 interface 4 to the Internet. As well, the communication device 1 may be connected to the World Wide Web via an Ethernet interface 3, while also being connected to the World Wide Web through a WLAN interface. In this embodiment, the communication device 1 may be connected to the World Wide Web via the WLAN interface 4 in order to browse through a search engine, while using the Ethernet interface 3 to check e-mail.

The communication device 1 can be interfaced wirelessly, such as to the 802.11 4, Bluetooth, 3G DO or a similar type of wireless interface. Further, the communication device 1 can be interfaced via a hardwire connection such as through the Ethernet interface 3. As well, a connection can be made to a network such as a Local Area Network (LAN) 7, the Internet 6, or to another communication device 5 such as a cellular telephone, PDA, or similar device. The interfaces can all be located within one communication device such as, for example, a laptop computer, that may have an Ethernet port, a wireless card, a Bluetooth chip, and a landline phone connection port. In accordance with embodiments of the present invention, two or more interfaces may be utilized simultaneously to access one or more network services.

The selection of the interface assigned to each application may be dynamically determined through the use of a resource management module 9 located within the communication device 1. This module 9 can be programmed to select to which interface each network application should be assigned based on necessary bandwidth or other criteria. These other criteria might include network security, stability, signal strength, type or a similar criteria. Alternatively, one embodiment allows for the user of the communication device 1 to make these assignments. In one embodiment of the invention, the user can program the module to select an interface based on their own criteria. As well, the user may also be able to manually bind each interface to each network application on the communication device 1, if desired.

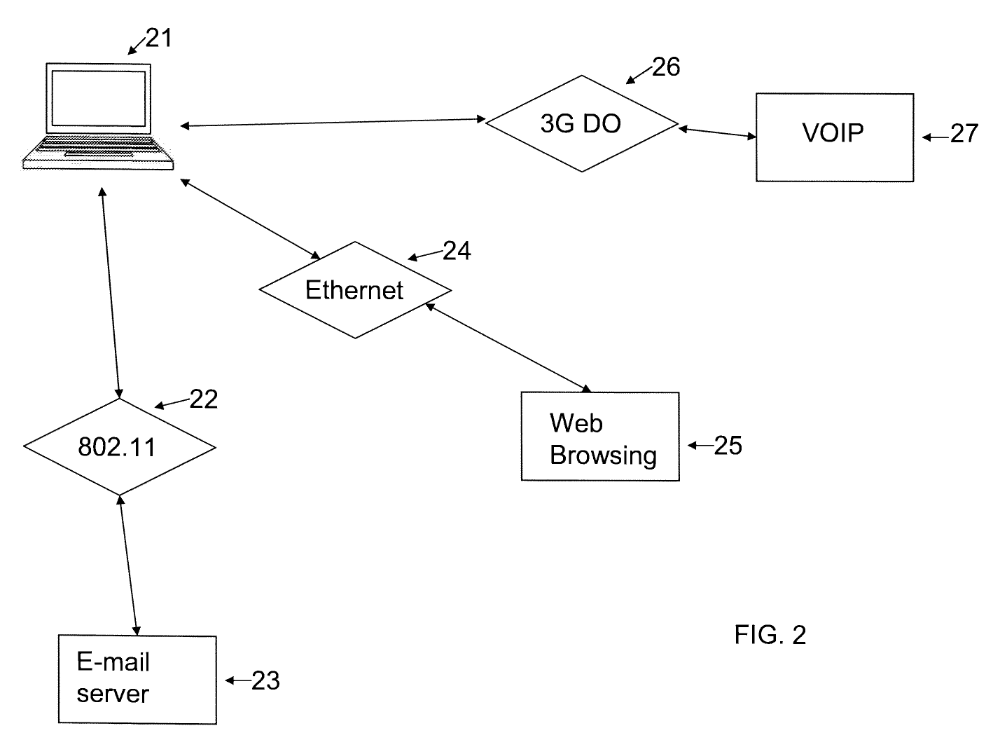

FIG. 2 provides another example of an arrangement in which multiple network applications can be accessed and utilized simultaneously through different network interfaces. In the illustrated embodiment, the communication device 21, such as a laptop computer, desktop computer, PDA, or the like, may be interfaced via a first interface 22 to a network (not shown) and have a network application 23, such as email, accessing an e-mail server through that network. The first interface 22 may be any one of the aforementioned wireless, LAN, hardwire or similar communication device interface connection. In this embodiment, for example, an 802.11 connection is established. Simultaneously, the communication device 21 can be interfaced to the same or a different network via an 3G DO interface 26 and be running applications accessing voice over internet protocol (VOIP) services 27. Further, the communication device 21 can be simultaneously running a web browser 25 to obtain access to the World Wide Web through an Ethernet interface 24 to the same or another network. Thus, network services are accessed on networks through interfaces which are best suited for each, respectively. This allows for applications, for example, needing faster connection speed to be connected via an interface that has a higher bandwidth, allowing for faster data transfer.

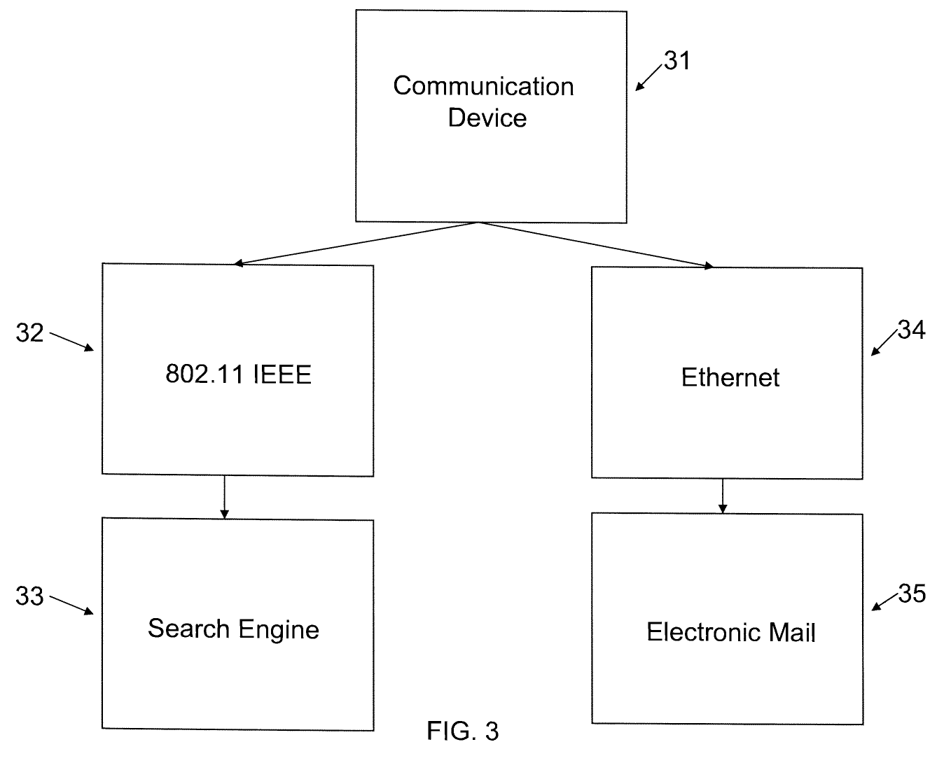

FIG. 3 illustrates a block flow diagram of an arrangement in accordance with an embodiment of the present invention wherein two interfaces 32, 34 are utilized simultaneously with a communication device 31. Although the illustrated embodiment has two interfaces, one of skill in the art will appreciate that any practical number of interfaces may be provided. Again, applications running on the communication device requiring network services can be assigned to an appropriate network interface, either manually via user input or via a resource management module located within the communication device 31 such as the resource management module 9 in FIG. 1.

The communication device 31 is provided with a first interface 32 and a second interface 34, such as 802.11 IEEE and Ethernet, respectively. Applications running on the communication devices 31, such as a web browser and an e-mail application, may access appropriate services through the interfaces. For example, the web browser application may access a search engine 33 through the 802.11 interface, while the e-mail application accesses an e-mail server through the Ethernet interface.

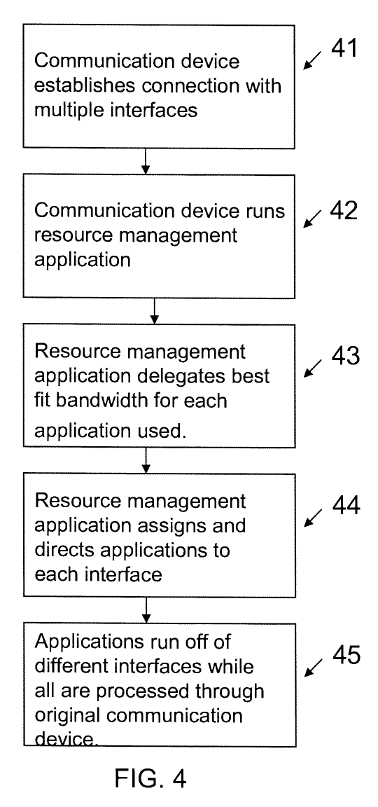

FIG. 4 illustrates an embodiment of the present invention wherein the resource management module is utilized to select which network interface is delegated to each application running on the communication device. The communication device first establishes a connection with multiple interfaces (block 41), such as the Ethernet, 802.11, 3G DO, dial-up, or the like, before the resource management module runs (block 42). This may include detection of the available network interfaces.

Once the resource management module is run (block 42), the module delegates the best fit bandwidth for each network application (block 43) in order to direct the accessing of network services by an application to the selected interface (block 44). The module then directs the applications to appropriate interfaces on the communication device (block 44) for each application to run at an efficient speed due to bandwidth usage. For instance, if the resource management module has multiple tasks to handle, some requiring large downloads, others requiring none, the module may direct the application requiring downloads to an interface such as Ethernet, or WLAN, dependent on the interface connection types available to the communication device.

In directing applications to the various network interfaces, the resource management module may assign a different IP address for the communication device for each network interface.

In one embodiment, if multiple tasks each require larger bandwidth, then the tasks may need to be assigned to a specified network interface allowing for this. If, for instance, there are two applications requiring large tasks to be completed, and only an Ethernet and Bluetooth connection are available, the module may direct both tasks through the Ethernet interface instead of utilizing both network interfaces. The network services required by the applications may then be accessed through the assigned interface 45.

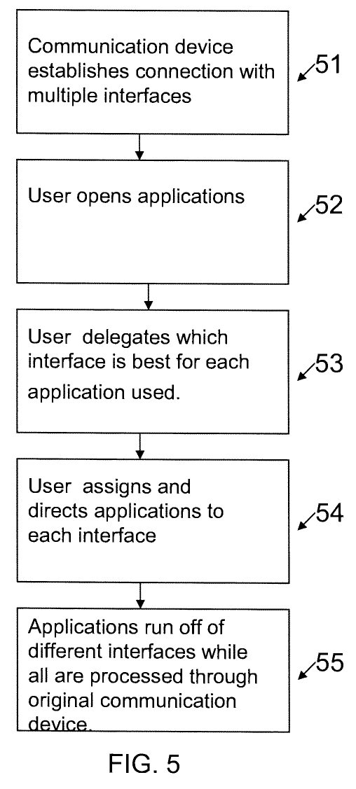

FIG. 5 illustrates another embodiment of the present invention wherein the selection of the network interfaces for various applications is made by the user of the communication device. The communication device establishes a connection to multiple interfaces (block 51) when the device is turned “on.” The user may open an application (block 52), and then decide to which interface each application should be directed (block 53). The user may decide this from a continual use of the application, such as electronic mail, that will be more interactive, or the necessity for large file downloads that will need more bandwidth to optimize the speed at which it is downloaded.

Next, the user must then direct the application to the desired interface connection (block 54) to be utilized. The user may also be able to exchange these selections during use if one application is being used more frequently or if new application are opened. The user can then still attempt to optimize the bandwidth usage during network access. For example, if the user completes his or her downloading on a web browser application that is accessing a network service through a broadband Ethernet interface and wants to begin large file downloads through an email server running on a slower speed wireless interface, the user may then switch interfaces for these applications before beginning the download. In one embodiment, this is made possible by linking the port number that the application is utilizing to the interface. Finally, the applications will run off different interfaces based on the users delegation while all may be processed through a singular communication device (block 55).

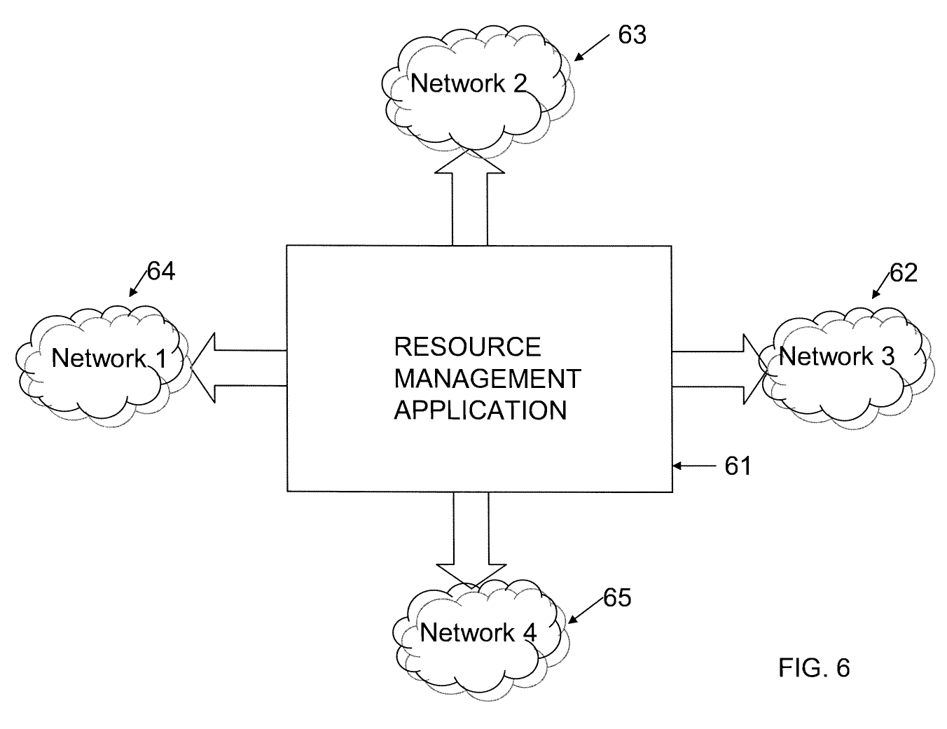

FIG. 6, illustrates the distribution technique of the resource management module 61 that may be located within the communication device. The module 61 interacts with a central processor of the communication device to allow various applications to access network services from one or more networks 62, 63, 64, 65 through the interface connections on the communication device. The module 61 may read the type of interface connection, the bandwidth type and the I.P. address associated with the interface. The interface connection can be of any type, such as Ethernet, dial-up, Bluetooth, wireless, or the like. Once this is completed, the module 61 may read the application type needing to be run through the interface.

For larger applications, the larger bandwidth is chosen in order to allow the application run at a faster speed. For instance, a file download from an email application would not be processed through a dial up connection when a web browser is running off of a WLAN connection. As well, if there are multiple applications needing to be assigned to one interface, while other interfaces are used by only one application, the module 61 can delegate which is a better interface to handle more data packets, thereby improving overall efficiency.

For example, in the embodiment of FIG. 6, if network 1 64, network 2 63, network 3 62 and network 4 65 are providing network services such as an email server, VOIP, a network browser, and PDA, respectively, and the only interfaces with the communication device are a Bluetooth, a wireless 802.11 and an Ethernet connection, the resource management module 61 may direct the VOIP to the Ethernet connection, the email server and network browser to the wireless 802.11 connection and the PDA to the Bluetooth connection. This delegation will allow for the best connection speeds and interface types for the utilized applications. As well, similar to the embodiment of FIG. 5 described above, if the network applications being run on the communication device and being assigned a network interface through the resource management module begin to require more bandwidth, while others are remaining idle, the resource management module may be programmed to switch network interface through which the network applications is accessing a network service.

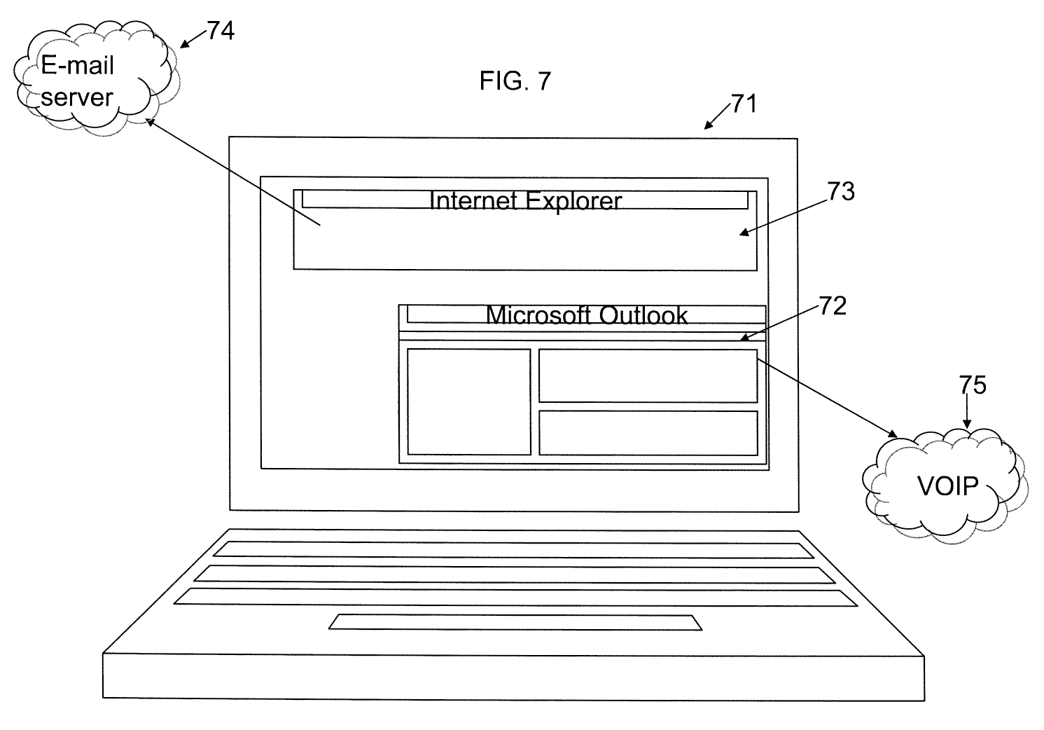

FIG. 7 illustrates an exemplary screen shot of how the application window types may appear on the communication device 71, such as a laptop computer or a similar computing device. A web browser application 73 is open and running at the same time on the communication device 71 as an electronic mail application 72, with each running off of different network interfaces 74 and 75 and on a different network. As described above, these two applications can also be accessing network services on the same network, but through two different network interfaces in order to improve the connection speed. Both applications can be seen simultaneously, but the connections speeds of each application window may be optimized.

As described above, the selection of the network interface for one or more applications may be based on achieving the best bandwidth. In addition to bandwidth, other criteria may be used in the selection of a network interface. For example, in various embodiments, the selection may be based on one or more of the following parameters (either individually or in any combination): bandwidth, signal strength, network security, and network signal compatibility. Of course, those skilled in the art will understand that any number of other parameters may also be used and are contemplated within the scope of this invention.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A communication method comprising:
interfacing a communication device with one or more networks through two or more network interfaces simultaneously; and
accessing two or more network services, each network service being accessed through a different one of the two or more network interfaces.

2. The method of claim 1 further comprising: selecting network interfaces to access network services corresponding to applications being run on the communication device.

3. The method of claim 2 wherein the selecting network interfaces includes dynamically selecting a network interface based on one or more communication parameters.

4. The method of claim 2 wherein the selecting network interfaces includes selecting a network interface based on predetermined network criteria.

5. The method of claim 3 wherein the selecting a network interface is based on bandwidth.

6. The method of claim 3 wherein the selecting a network interface is based on network signal strength.

7. The method of claim 3 wherein the selecting a network interface is based on network security.

8. The method of claim 3 wherein the selecting a network interface is based on network signal compatibility.

9. The method of claim 1 wherein a user of the communication device is allowed to select a network interface for each of one or more applications.

10. A communication device, comprising:
two or more network interfaces adapted to allow access to two or more network services, each network service being accessed through a different one of the two or more network interfaces simultaneously; and
a resource management module adapted to select network interfaces to access network services corresponding to applications being run on the communication device.

11. The communication device of claim 10, wherein at least one network interface is 3G DO.

12. The communication device of claim 10, wherein at least one network interface is IEEE 802.11.

13. The communication device of claim 10, wherein at least one network interface is an Ethernet connection.

14. The communication device of claim 10, wherein the resource management module is adapted to dynamically select a network interface.

15. The communication device of claim 10, wherein the resource management module is adapted to select a network interface based on user input.

16. The communication device of claim 10, wherein the communication device is a portable computing device.

17. A computer program product for executing a method adapted to select two or more network interfaces, comprising program coding encoded on a computer-readable medium for carrying out the steps of claim 1, when the program is run on a communication device.

18. A computer program product comprising program coding stored on a computer-readable medium for carrying out the method of claim 1, when the program product is run on a communication device.
